(19) United States
(12) Patent Application Publication
(10) Pub. No.: US 2025/0377219 A1
(43) Pub. Date: Dec. 11, 2025

(54) POSITION DETECTION SYSTEM, ACTUATOR, AND POSITION DETECTION METHOD

(71) Applicant: Fanuc Corporation, Minamitsuru-gun, Yamanashi (JP)

(72) Inventor: Taichi TAGUCHI, Minamitsuru-gun, Yamanashi (JP)

(73) Assignee: Fanuc Corporation, Minamitsuru-gun, Yamanashi (JP)

(21) Appl. No.: 18/877,015

(22) PCT Filed: Jul. 8, 2022
(86) PCT No.: PCT/JP2022/027152

§ 371 Date: Dec. 19, 2024

(51) Int. Cl. G01D 5/14

(52) U.S. Cl. CPC G01D 5/14

(57) ABSTRACT

A position detection system includes a primary encoder that detects the position of a motor shaft, a secondary encoder that detects the position of an output shaft of a reducer, and a calculation unit. The reduction ratio of the reducer is 1/n, where n is a non-integer. The calculation unit calculates a plurality of position calculation values related to the position within one rotation of the motor shaft on the basis of the position within one rotation of the secondary encoder, and calculates the total number of rotations of the secondary encoder on the basis of the actual position value related to the position within one rotation of a rotor and the plurality of position calculation values.

### CROSS REFERENCE TO RELATED APPLICATIONS

This is the U.S. National Phase application of PCT/JP2022/027152, filed Jul. 8, 2022, the disclosure of this application being incorporated herein by reference in its entirety for all purposes.

### FIELD OF THE INVENTION

The present invention relates to a position detection system, an actuator, and a position detection method.

### BACKGROUND OF THE INVENTION

Actuator includes a servo motor and a speed reducer that are connected to each other. A primary encoder is connected to a motor shaft of the servo motor for detecting an absolute position within one rotation of the motor shaft and the total number of rotations of the motor shaft. Likewise, a secondary encoder is connected to an output shaft of the speed reducer for detecting an absolute position within one rotation of the output shaft and the total number of rotations of the output shaft (refer to, for example, Japanese Unexamined Patent Publication (Kokai) No. 2007-113932). Information detected by each encoder is stored in a memory.

Japanese Unexamined Patent Publication (Kokai) No. 2006-300596 proposes a method in which the reduction ratio of a speed reducer is defined as 1/n (where n is a non-integer), the value of a “judgment criteria” is calculated from the position of a secondary encoder, and a +1 rotation of the secondary encoder is determined based on the value of the judgment criteria and the result of determining whether the position of the primary encoder are positive or negative.

### Patent Literature

PTL 1: Japanese Unexamined Patent Publication (Kokai) No. 2007-113932

PTL 2: Japanese Unexamined Patent Publication (Kokai) No. 2006-300596

### SUMMARY OF THE INVENTION

However, in the method of Japanese Unexamined Patent Publication (Kokai) No. 2006-300596, a battery-less absolute encoder cannot be achieved when the output shaft makes two or more rotations.

Therefore, a position detection system which can be used without requiring an additional battery even when the output shaft makes two or more rotations is desired.

According to a first aspect of the present disclosure, there is provided a position detection system comprising a primary encoder for detecting a position of a motor shaft of a motor, a secondary encoder for detecting a position of an output shaft of a speed reducer coupled to the motor, and a calculation unit, wherein a reduction ratio of the speed reducer is 1/n, where n is a non-integer, the calculation unit calculates a plurality of calculated position values relating to an absolute position within one rotation of the motor shaft with the primary encoder based on an absolute position within one rotation of the secondary encoder, and the calculation unit calculates a total number of rotations of the secondary encoder based on an actual position value relating to the absolute position within one rotation of the motor shaft detected by the primary encoder and the plurality of calculated position values.

According to another aspect of the present disclosure, a position detection system comprising a primary encoder for detecting a position of a motor shaft of a motor, a secondary encoder for detecting a position of an output shaft of a speed reducer coupled to the motor, and a calculation/judgment unit, wherein the calculation/judgment unit calculates a plurality of calculated position values relating to an absolute position within one rotation of the motor shaft based on an absolute position within one rotation of the secondary encoder, and the calculation/judgment unit further judges that there is an abnormality in the position of at least one of the primary encoder and the secondary encoder when an absolute value of a deviation between an actual position value regarding an absolute position within one rotation of the motor shaft detected by the primary encoder and the calculated position value is equal to or greater than a predetermined value.

The object, features, and advantages of the present disclosure will become more apparent from the following description of the embodiments in conjunction with the accompanying drawings.

### BRIEF DESCRIPTION OF THE DRAWINGS

FIG. 1 is a schematic side view of a position detection system based on a first embodiment of the present disclosure.

FIG. 2 is a first flowchart showing the operations of the position detection system shown in FIG. 1.

FIG. 3 is a view showing the relationship between the position of the output shaft and the position of the input shaft.

FIG. 4 is another view showing the relationship between the position of the output shaft and the position of the input shaft.

FIG. 5 is a second flowchart showing the operations of a position detection system based on a second embodiment.

### DETAILED DESCRIPTION OF EMBODIMENTS OF THE INVENTION

The embodiments of the present disclosure will be described below with reference to the attached drawings. In the drawings, corresponding constituent elements have been assigned common reference signs.

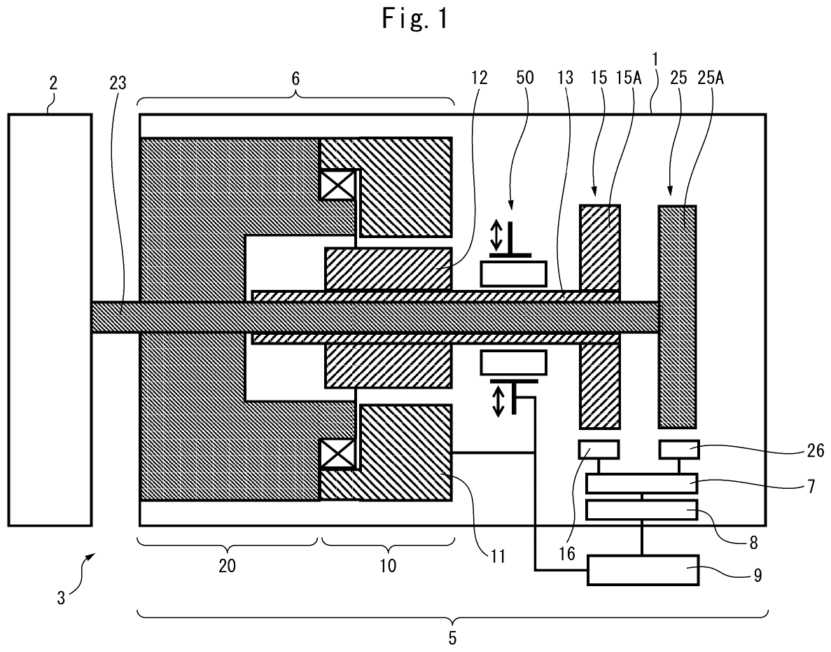

FIG. 1 is a schematic side view of a position detection system based on a first embodiment of the present disclosure. The position detection system 5 is incorporated into a machine 3 having a shaft, for example, a robot 3. Though the case in which the position detection system 5 is incorporated into the robot 3 will be described below, the same applies to the case in which the position detection system 5 is incorporated into another machine 3 having a shaft, for example, a machine tool.

In FIG. 1, an actuator 6 arranged in a link 1 comprises a motor 10, for example, a servo motor and a speed reducer 20, which are connected with each other, coupled to a motor shaft 13 of the motor 10. The motor 10 comprises a rotor 12 which rotates integrally with the motor shaft 13, and a stator 11 arranged so as to surround the rotor 12. The tip of an output shaft 23 of the speed reducer 20 is connected to a link 2. Thus, the actuator 6 composed of the motor 10 and the speed reducer 20 rotates the link 2 relative to the link 1 within a predetermined operating range to perform positioning control thereof. The speed reduction ratio n of the speed reducer 20 is a positive non-integer, for example, n=α+1/β (where α and β are positive numbers greater than 1).

The motor shaft 13 is, for example, a hollow shaft, and a primary encoder 15 comprising a rotating disk 15A is attached to a rear end thereof. The primary encoder 15 is, for example, an incremental encoder, and outputs A-phase, B-phase, and Z-phase signals. The output signals are detected by a detection unit 16, which detects an absolute position Op within one rotation of the motor shaft 13 and the total number of rotations by a known method. The detected information is stored in a memory 7, for example, a volatile memory.

The output shaft 23 extends through the hollow motor shaft 13 toward the motor 10, and a secondary encoder 25 comprising a rotating disk 25A is attached to a rear end of the output shaft 23. The secondary encoder 25 is, for example, an incremental encoder, and outputs A-phase, B-phase, and Z-phase signals. The output signals are detected by a detection unit 26, which detects an absolute position θs within one rotation of the output shaft 23 and the total number of rotations i by a known method. The detected information is stored in a memory 7, for example, a volatile memory.

The information stored in the memory 7 is capable of being stored for a certain period of time due to a battery 8, for example, a button battery or a capacitor. The position detection system 5 shown in FIG. 1 comprises a common memory 7 and a common battery 8 for the primary encoder 15 and the secondary encoder 25. However, the primary encoder 15 and the secondary encoder 25 may each have a separate memory and battery.

The information stored in the memory 7 is supplied to a controller 9. The controller 9 may be a controller for controlling the machine 3, or an LSI mounted on the encoders 15 and 25. Based on the supplied information, the controller 9 drives and controls the motor 10, and performs a positioning operation to position the link 2 at a target position relative to the link 1. Further, a built-in brake 50 provided on the outer surface side of the motor shaft 13 is activated in response to an instruction from the controller 9 to brake the motor shaft 13. Furthermore, the controller 9 also serves to energize the primary encoder 15 and the secondary encoder 25 during operation of the machine 3.

The controller 9 additionally serves as a calculation unit for calculating a plurality of calculated position values relating to the absolute position of the primary encoder 13 within one rotation of the motor shaft 13 based on the absolute position of the secondary encoder 25 within one rotation, and for calculating a total number of rotations of the secondary encoder 25 based on the actual position value relating to the absolute position within one rotation of the motor shaft 13 detected by the primary encoder 15 and the plurality of calculated position values.

The controller 9 further serves as a calculation/judgment unit for calculating a calculated position value relating to the absolute position within one rotation of the motor shaft 13 based on the absolute position within one rotation of the output shaft 23 detected by the secondary encoder 25, and for determining that there is an abnormality in the position of at least one of the primary encoder 15 and the secondary encoder 25 when the absolute value of the deviation between the actual position value and the calculated position value relating to the absolute position within one rotation of the motor shaft 13 detected by the primary encoder 15 is equal to or greater than a predetermined value.

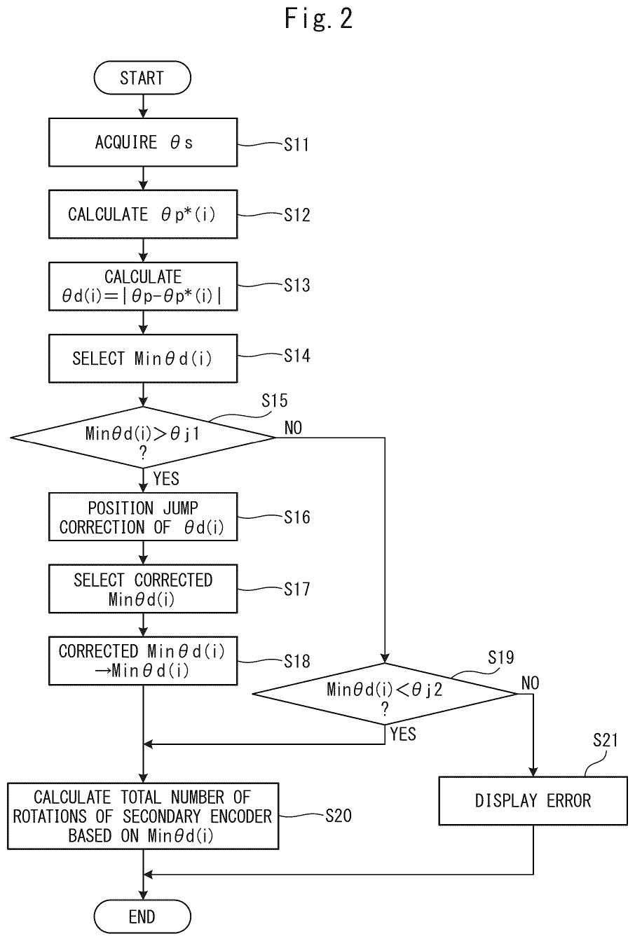

FIG. 2 is a first flowchart showing the operations of the position detection system shown in FIG. 1. The contents of the program shown in FIG. 2 are stored in a storage unit (not illustrated) in the controller 9 or in the memory 7. The contents shown in FIG. 2 are appropriately executed when the motor 10 is driven.

First, in step S11, the secondary encoder 25 detects the absolute position θs within one rotation of the output shaft 23. Next, in step S12, the controller 9 uses the detected absolute position θs to calculate a calculated position value θp*(i) relating to the absolute position of the primary encoder 15 within one rotation, based on the following formula (1) (where i is a positive number equal to or less than β):

$$θ p * ( i ) = MOD [ \{ θs \times ( α + 1 / β ) + ( 360 / β ) \times ( i - 1 ) \} \div 360 ] \times 360 \qquad formula ( 1 )$$

Note that “MOD []” refers to a function for calculating the remainder of a division.

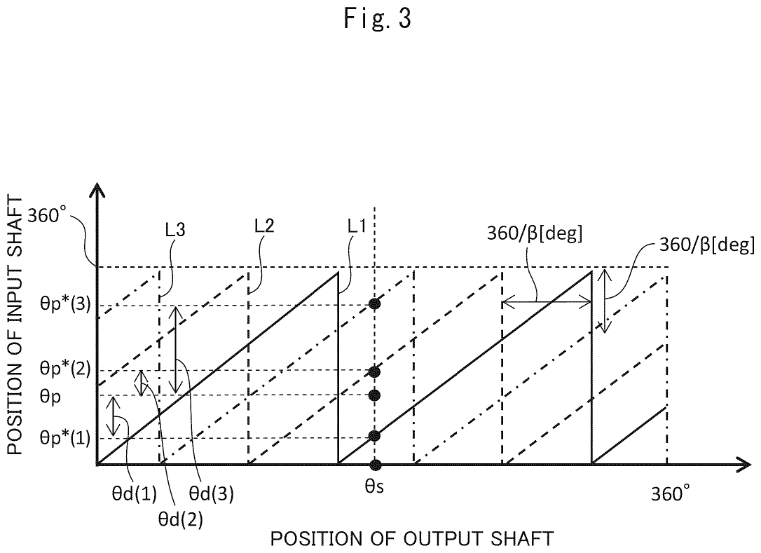

FIG. 3 is a view showing the relationship between the position of the output shaft and the position of the input shaft. In FIG. 3, the horizontal axis represents the position of the output shaft 23 of the speed reducer 20, and the vertical axis represents the position of the input shaft. The “position of the input shaft” means the position of the input shaft input to the secondary encoder 25. In the present description, since the secondary encoder 25 is connected downstream of the primary encoder 15, the “position of the input shaft” can also be rephrased as the position of the rotating disk 15A of the primary encoder 15 or the position of the motor shaft 13. In FIG. 3, both the horizontal axis and the vertical axis are shown in degrees. As described above, the reduction ration of the speed reducer 20 is n=α+1/β (where α and β are positive numbers greater than 1), and in the example shown in FIG. 3, α=2 and β=3.

In FIG. 3, three lines L1, L2, and L3 are shown. The number of these lines L1, L2, and L3 is equal to the value of β described above. The solid line L1 represents the position of the input shaft as the output shaft 23 is making its first rotation. The dashed line L2 represents the position of the input shaft as the output shaft 23 is making its second rotation. The dash-dotted line L3 represents the position of the input shaft as the output shaft 23 is making its third rotation.

As can be understood from FIG. 3, the position detection system 5 of the first embodiment can detect up to β rotations of the output shaft 23. The position of the output shaft 23 differs between the first rotation and the second rotation. In the first embodiment, the total number of rotations of the output shaft 23 is obtained by utilizing the difference between the position in the first rotation and the position in the second rotation.

Since β=3 in the example shown in FIGS. 3, θp*(1), θp*(2), and θp*(3) are shown on the vertical axis in FIG. 3. These θp*(i) are values on the vertical axis corresponding to the intersections between the absolute position θs of the output shaft 23 and the three lines L1, L2, and L3.

In step S13, the controller 9 acquires a position detection value Op relating to the absolute position within one rotation of the motor shaft 13 detected by the primary encoder 15. The controller 9 then calculates a plurality of absolute values θd(i) (=|θp−θp*(i)|) of deviations between the position detection value θp and the plurality of calculated position values θp*(i). In FIG. 3, the absolute values of the deviations θd(1) (=|θp−θp*(1)|), θd(2) (=|θp−θp*(2)|), and θd(3) (=|θp−θp*(3)|) are indicated by arrows.

Next, in step S14, the controller 9 selects a minimum value Minθd(i) from the plurality of absolute values θd(1), θd(2), and θd(3) of FIG. 3. Since θd(2)<θd(1)<θd(3) in the example shown in FIG. 3, θd(2) corresponds to the minimum value Minθd(i).

In step S15, the controller 9 compares the selected minimum value Minθd(i) with a first error judgment value θj1. The first error judgment value θj1 is calculated in advance based on the following formula (2):

$$θ j 1 = 360 / β - n - θ sa\_max - θpa\_max - θnois\_max \qquad formula ( 2 )$$

θsa represents the detection accuracy determined according to the characteristics of the secondary encoder 25, and θsa_max is the value when the detection accuracy is the lowest. θpa represents the detection accuracy determined according to the characteristics of the primary encoder 15, and θpa_max is the value when the detection accuracy is the lowest. θnois represents the width of the disturbance of the position detection system 5, and θnois_max the maximum value thereof.

When it is determined in step S15 that the minimum value Minθd(i) is not greater than the first error judgment value θj1, it is determined that there are no abnormalities, and the process proceeds to step S19. Then, in step S19, the minimum value Minθd(i) is compared with a second error judgment value θj2. The second error judgment value θj2 is calculated in advance based on the following formula (3):

$$θ j 2 \geq θ j 1 - 360 = n \cdot θ sa\_max + θ pa\_max + θ nois\_max \qquad formula ( 3 )$$

As can be understood from formula (3), the second error judgment value θj2 is less than the first error judgment value θj1.

When it is determined that the minimum value Minθd(i) is not less than the second error judgment value θj2, the process proceeds to step S21. In step S21, it is determined that there is an abnormality in the position of at least one of the primary encoder 15 and the secondary encoder 25. The controller 9 then determines that this is a detection error and stops the operation of the motor 10. At this time, this may be displayed on a display unit (not illustrated), for example, on a screen of a teach pendant.

Conversely, when it is determined in step S19 that the minimum value Minθd(i) is less than the second error judgment value θj2, the process proceeds to step S20. In step S20, the controller 9 calculates the total number of rotations of the secondary encoder 25 based on the minimum value Minθd(i). Since θd(2) is the minimum value Minθd(i) in the example shown in FIG. 3, it is understood that the total number of rotations i is 2.

In this manner, the process of acquiring the total number of rotations of the secondary encoder 25 of the first embodiment of the present disclosure does not require an additional battery. Therefore, in the first embodiment of the present disclosure, even if the output shaft 23 rotates two or more times, the position detection system 5 can be used without requiring an additional battery. In other words, even if the encoders 15, 25 are moved in a situation where the controller 9 is not supplying power to the encoders 15, 25, the position detection system 5 of the first embodiment can acquire the total number of rotations of the output shaft 23.

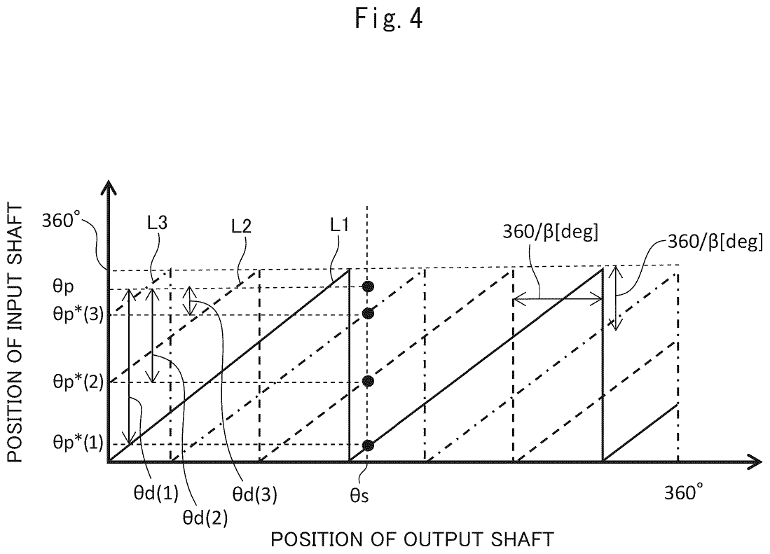

When it is determined in step S15 that the minimum value Minθd(i) is greater than the first error judgment value θj1, the process proceeds to step S16. FIG. 4 is another view showing the relationship between the position of the output shaft and the position of the input shaft, similar to FIG. 3. The case in which it is determined in step S15 that the minimum value Minθd(i) is greater than the first error judgment value θj1 is, for example, a situation such as the example shown in FIG. 4.

In FIG. 4, the absolute position θs within one rotation of the output shaft 23 is in a different position from that of FIG. 3. When the absolute values of the deviation θd(1) (=|θp−θp*(1)|), θd (2) (=|θp−θp*(2)|), and θd(3) (=|θp−θp*(3)|) of the example shown in FIG. 4 are compared with each other, θd(3)<θd(2)<θd(1).

In FIG. 4, the minimum value Minθd(i) should be θd(1), and it is clear that θd(3) is incorrectly set as the minimum value Minθd(i). However, since the position of the motor shaft 13 relative to the primary encoder 15 is near 0° (near 360°), it is difficult to make such a determination. Thus, assuming that the position of the motor shaft 13 relative to the primary encoder 15 is near 0°, in step S16, the controller 9 performs position jump correction on the absolute value of the deviation θd(i) acquired in step S13.

Formula (4) used in the position jump correction is as follows:

$$θ d ( i ) = \vert θ p - θ {p}^{*} ( i ) \vert = 360 - 360 ( i - 1 ) / β - n θ sa - θ pa - θ noise \qquad formula ( 4 )$$

As a result, θd(1), θd(2), and θd(3) are corrected according to the following formulas (5) to (7):

$$θ d ( 1 ) = \vert θ p - θ {p}^{*} ( 1 ) \vert = 360 - n θ sa - θ pa - θ nois \qquad Formula ( 5 )$$

$$θ d ( 2 ) = \vert θ p - θ {p}^{*} ( 2 ) \vert = 240 - n θ sa - θ pa - θ nois \qquad Formula ( 6 )$$

$$θ d ( 3 ) = \vert θ p - θ {p}^{*} ( 3 ) \vert = 120 - n θ sa - θ pa - θ nois \qquad Formula ( 7 )$$

Furthermore, in formulas (4) to (7), θsa and θpa are approximately 0.01 degrees, and θnois is approximately several degrees.

In step S17, the controller 9 selects the minimum value Minθd(i) from the plurality of absolute values θd(i) corrected in this manner. In the example shown in FIG. 4, the minimum value Minθd(i) is the corrected absolute value θd(1). By such position jump correction, the correct minimum value Minθd(i) (the corrected absolute value θd(1) of FIG. 4) is selected.

In step S18, the correct minimum value Minθd(i) after correction is set as the minimum value Minθd(i). The process then proceeds to step S20, and the total number of rotations of the secondary encoder 25 is calculated in accordance with the new minimum value Minθd(i) in the same manner as described above. Since θd(1) is the minimum value Minθd(i) in the example shown in FIG. 4, it is understood that the total number of rotations i is 1.

With this configuration, even if the position of the motor shaft 13 relative to the primary encoder 15 is near 0°, the total number of rotations of the secondary encoder 25 can be accurately calculated.

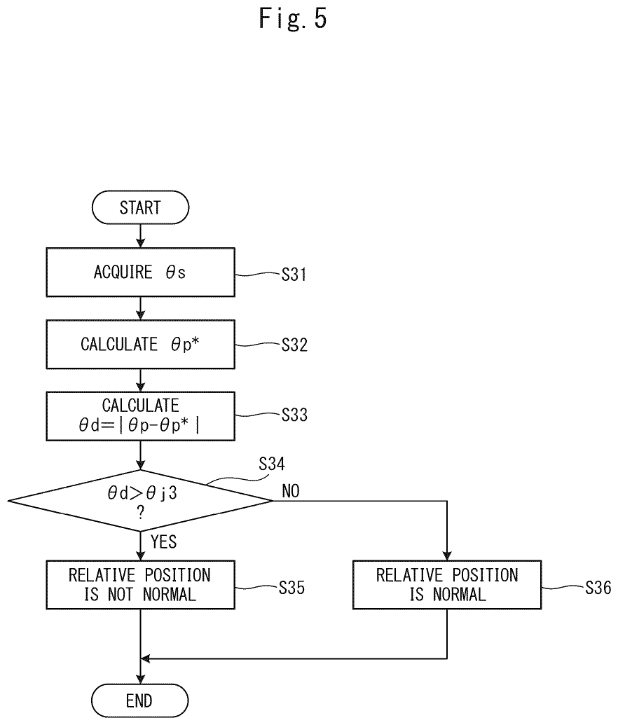

FIG. 5 is a second flowchart showing the operations of the position detection system based on a second embodiment. The contents of the program shown in FIG. 5 are stored in a storage unit (not illustrated) in the controller 9 or in the memory 7. The contents shown in FIG. 5 are appropriately executed when the motor 10 is driven.

The reduction ratio n of the speed reducer 20 of the second embodiment is not limited to the foregoing. Specifically, the reduction ratio n in this case may be 1/α (where α is a positive number greater than 1). The second embodiment also includes the case in which an additional speed reducer (not illustrated) is arranged between the output shaft 23 and the secondary encoder 25, and the overall reduction ratio of the speed reducer 20 and the additional speed reducer is 1/α′ (α′ is a positive number greater than 1).

First, in step S31, in the same manner as described above, the secondary encoder 25 detects a position detection value θs relating to the absolute position within one rotation of the output shaft 23. In step S32, in the same manner as described with reference to FIG. 3, the controller 9 as a calculation/judgment unit calculates the calculated position value θp* relating to the absolute position of the primary encoder 15 within one rotation based on the following formula (8) using the position detection value θs of the detected absolute position.

$$θ {p}^{*} = MOD [ \{ ( θ s \times α \times β ) \} \div 360 ] \times 360 \qquad formula ( 8 )$$

Next, in step S33, the controller 9 calculates the absolute value θpd of the deviation between the position detection value θs of the primary encoder 15 and the calculated position value θp* based on the following formula (9):

$$θ pd = \vert θ {p}^{*} - θ p \vert \qquad formula ( 9 )$$

In step S34, the controller 9 determines whether the absolute value of the deviation θpd is greater than the third error judgment value θj3. The absolute value of the deviation θpd represents a deviation in the detection position between the primary encoder 15 and the secondary encoder 25. In an ideal state without backlash of the speed reducer 20 and various detection errors, the absolute value of the deviation θpd is 0. Thus, the third error judgment value θj3 is a value greater than zero that is predetermined by the operator.

When it is determined in step S34 that the absolute value of the deviation θpd is greater than the third error judgment value θj3, it is determined that the relative position between the primary encoder 15 and the secondary encoder 25 is abnormal (step S35). In this case, it is determined that there is an abnormality in the set position of the primary encoder 15 and/or the secondary encoder 25, and the controller 9 stops the operation of the motor 10. At this time, this may be displayed on a display unit (not illustrated), for example, a screen of a teach pendant.

Conversely, when it is determined in step S34 that the absolute value of the deviation θpd is not greater than the third error judgment value θj3, it is determined that the relative position between the primary encoder 15 and the secondary encoder 25 is normal (step S36), and the process ends.

In this manner, the process of determining whether or not there is an abnormality in the relative position between the primary encoder 15 and the secondary encoder 25 of the second embodiment of the present disclosure does not require an additional battery. Thus, in the second embodiment, an abnormality in the position of the primary encoder 15 and/or the secondary encoder 25 can be easily detected without requiring an additional battery.

Furthermore, the computer program for executing the processing of the controller 9 as a calculation unit and a calculation/judgment unit may be provided in a form recorded on a computer-readable recording medium such as a semiconductor memory, a magnetic recording medium, or an optical recording medium.

### Aspects of the Present Disclosure

According to a first aspect, there is provided a position detection system comprising a primary encoder for detecting a position of a motor shaft of a motor, a secondary encoder for detecting a position of an output shaft of a speed reducer coupled to the motor, and a calculation unit, wherein a reduction ratio of the speed reducer is 1/n, where n is a non-integer, the calculation unit calculates a plurality of calculated position values relating to an absolute position within one rotation of the motor shaft with the primary encoder based on an absolute position within one rotation of the secondary encoder, and the calculation unit calculates a total number of rotations of the secondary encoder based on an actual position value relating to the absolute position within one rotation of the motor shaft detected by the primary encoder and the plurality of calculated position values.

According to a second aspect, in the first aspect, the calculation unit calculates the total number of rotations of the secondary encoder based on an absolute value of a deviation between the actual position value and the plurality of calculated position values.

According to a third aspect, in the first or second aspect, when a minimum value of the absolute value of the deviation between the actual position value and the plurality of calculated position values is greater than a predetermined first error judgment value, the calculation unit calculates the minimum value after correcting the plurality of calculated position values.

According to a fourth aspect, in any one of the first through third aspect, when a minimum value of the absolute value of the deviation between the actual position value and the plurality of calculated position values is not less than a predetermined second error judgment value that is less than the first error judgment value, the calculation unit calculates a total number of rotations of the secondary encoder.

According to a fifth aspect, there is provided an actuator comprising a motor, a speed reducer coupled to the motor, a primary encoder for detecting a position of a motor shaft of the motor, a secondary encoder for detecting a position of an output shaft of the speed reducer, and a calculation unit, wherein a reduction ratio of the speed reducer is 1/n, where n is a non-integer, the calculation unit calculates a plurality of calculated position values relating to an absolute position within one rotation of the motor shaft with the primary encoder based on an absolute position within one rotation of the secondary encoder, and the calculation unit calculates a total number of rotations of the secondary encoder based on an actual position value relating to the absolute position within one rotation of the motor shaft detected by the primary encoder and the plurality of calculated position values.

According to a sixth aspect, in the fifth aspect, the calculation unit calculates the total number of rotations of the secondary encoder based on an absolute value of a deviation between the actual position value and the plurality of calculated position values.

According to a seventh aspect, in the fifth or sixth aspect, when a minimum value of the absolute value of the deviation between the actual position value and the plurality of calculated position values is greater than a predetermined first error judgment value, the calculation unit calculates the minimum value after correcting the plurality of calculated position values.

According to an eighth aspect, in any of the fifth through seventh aspects, when a minimum value of the absolute value of the deviation between the actual position value and the plurality of calculated position values is not less than a predetermined second error judgment value that is less than the first error judgment value, the calculation unit calculates the total number of rotations of the secondary encoder.

According to a ninth aspect, there is provided a position detection method for a position detection system comprising a primary encoder for detecting a position of a motor shaft of a motor and a secondary encoder for detecting a position of an output shaft of a speed reducer coupled to the motor, wherein a reduction ratio of the speed reducer is 1/n, where n is a non-integer, the method comprising the steps of calculating a plurality of calculated position values relating to an absolute position within one rotation of the motor shaft with the primary encoder based on an absolute position within one rotation of the secondary encoder, and calculating a total number of rotations of the secondary encoder based on an actual position value relating to the absolute position within one rotation of the motor shaft detected by the primary encoder and the plurality of calculated position values.

According to a tenth aspect, in the ninth aspect, the method further comprises calculating a total number of rotations of the secondary encoder based on an absolute value of a deviation between the actual position value and the plurality of calculated position values.

According to an eleventh aspect, in the ninth or tenth aspect, the method further comprises when a minimum value of the absolute value of the deviation between the actual position value and the plurality of calculated position values is greater than a predetermined first error judgment value, the calculation unit calculates the minimum value after correcting the plurality of calculated position values.

According to a twelfth aspect, in any one of the ninth to eleventh aspect, the method further comprises when a minimum value of the absolute value of the deviation between the actual position value and the plurality of calculated position values is not less than a predetermined second error judgment value that is less than the first error judgment value, calculating a total number of rotations of the secondary encoder.

According to a thirteenth aspect, there is provided a position detection system comprising a primary encoder for detecting a position of a motor shaft of a motor, a secondary encoder for detecting a position of an output shaft of a speed reducer coupled to the motor, and a calculation/judgment unit, wherein a reduction ratio of the speed reducer is 1/n, where n is a non-integer, the calculation/judgment unit calculates calculated position values relating to an absolute position within one rotation of the motor shaft based on an absolute position within one rotation of the output shaft detected by the secondary encoder, and the calculation/judgment unit further judges that there is an abnormality in the position of at least one of the primary encoder and the secondary encoder when an absolute value of a deviation between an actual position value regarding an absolute position within one rotation of the motor shaft detected by the primary encoder and the calculated position value is equal to or greater than a predetermined value.

According to a fourteenth aspect, there is provided an actuator comprising a motor, a speed reducer coupled to the motor, a primary encoder for detecting a position of a motor shaft of the motor, a secondary encoder for detecting a position of an output shaft of the speed reducer, and a calculation/judgment unit, wherein the calculation/judgment unit calculates a calculated position value relating to an absolute position within one rotation of the motor shaft based on an absolute position of the output shaft within one rotation detected by the secondary encoder, and the calculation/judgment unit further determines that there is an abnormality in the position of at least one of the primary encoder and the secondary encoder when an absolute value of a deviation between an actual position value relating to the absolute position within one rotation of the motor shaft detected by the primary encoder and the calculated position value is equal to or greater than a predetermined value.

According to a fifteenth aspect, there is provided a position detection method for a position detection system comprising a primary encoder for detecting a position of a motor shaft of a motor, and a secondary encoder for detecting a position of an output shaft of a speed reducer coupled to the motor, the method comprising the steps of calculating a calculated position value relating to an absolute position within one rotation of the motor shaft based on an absolute position of the output shaft within one rotation detected by the secondary encoder, and determining that there is an abnormality in the position of at least one of the primary encoder and the secondary encoder when an absolute value of a deviation between the actual position value relating to the absolute position within one rotation of the motor shaft detected by the primary encoder and the calculated position value is equal to or greater than a predetermined value.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

### Reference Signs List

1,2 link
3 machine (robot)
5 position detection system
6 actuator
7 memory
8 battery
9 controller (calculation unit, calculation/judgment unit)
10 motor
11 stator
12 rotor
13 motor shaft
15 primary encoder
16 detection unit
20 speed reducer
23 output shaft
25 secondary encoder
26 detection unit
50 built-in brake
θj1 first error judgment value
θj2 second error judgment value
θj3 third error judgment value

1. A position detection system comprising:
a primary encoder for detecting a position of a motor shaft of a motor,
a secondary encoder for detecting a position of an output shaft of a speed reducer coupled to the motor, and
a calculation unit, wherein
a reduction ratio of the speed reducer is 1/n, where n is a non-integer,
the calculation unit calculates a plurality of calculated position values relating to an absolute position within one rotation of the motor shaft with the primary encoder based on an absolute position within one rotation of the secondary encoder, and
the calculation unit calculates a total number of rotations of the secondary encoder based on an actual position value relating to the absolute position within one rotation of the motor shaft detected by the primary encoder and the plurality of calculated position values.

2. The position detection system according to claim 1, wherein the calculation unit calculates the total number of rotations of the secondary encoder based on an absolute value of a deviation between the actual position value and the plurality of calculated position values.

3. The position detection system according to claim 1, wherein when a minimum value of the absolute value of the deviation between the actual position value and the plurality of calculated position values is greater than a predetermined first error judgment value, the calculation unit calculates the minimum value after correcting the plurality of calculated position values.

4. The position detection system according to claim 1, wherein when a minimum value of the absolute value of the deviation between the actual position value and the plurality of calculated position values is not less than a predetermined second error judgment value that is less than the first error judgment value, the calculation unit calculates a total number of rotations of the secondary encoder.

5. An actuator comprising:
a motor,
a speed reducer coupled to the motor,
a primary encoder for detecting a position of a motor shaft of the motor,
a secondary encoder for detecting a position of an output shaft of the speed reducer, and
a calculation unit, wherein
a reduction ratio of the speed reducer is 1/n, where n is a non-integer,
the calculation unit calculates a plurality of calculated position values relating to an absolute position within one rotation of the motor shaft with the primary encoder based on an absolute position within one rotation of the secondary encoder, and
the calculation unit calculates a total number of rotations of the secondary encoder based on an actual position value relating to the absolute position within one rotation of the motor shaft detected by the primary encoder and the plurality of calculated position values.

6. The actuator according to claim 5, wherein the calculation unit calculates the total number of rotations of the secondary encoder based on an absolute value of a deviation between the actual position value and the plurality of calculated position values.

7. The actuator according to claim 5, wherein when a minimum value of the absolute value of the deviation between the actual position value and the plurality of calculated position values is greater than a predetermined first error judgment value, the calculation unit calculates the minimum value after correcting the plurality of calculated position values.

8. The actuator according to claim 5, wherein when a minimum value of the absolute value of the deviation between the actual position value and the plurality of calculated position values is not less than a predetermined second error judgment value that is less than the first error judgment value, the calculation unit calculates the total number of rotations of the secondary encoder.

9. (canceled)

10. (canceled)

11. (canceled)

12. (canceled)

13. A position detection system comprising:
a primary encoder for detecting a position of a motor shaft of a motor,
a secondary encoder for detecting a position of an output shaft of a speed reducer coupled to the motor, and
a calculation/judgment unit, wherein
the calculation/judgment unit calculates calculated position values relating to an absolute position within one rotation of the motor shaft based on an absolute position within one rotation of the output shaft detected by the secondary encoder, and
the calculation/judgment unit further judges that there is an abnormality in the position of at least one of the primary encoder and the secondary encoder when an absolute value of a deviation between an actual position value regarding an absolute position within one rotation of the motor shaft detected by the primary encoder and the calculated position value is equal to or greater than a predetermined value.

14. (canceled)

15. (canceled)
